(19) United States
(12) Patent Application Publication
(10) Pub. No.: US 2022/0374124 A1
(43) Pub. Date: Nov. 24, 2022

(54) Classifying Mechanical Interactions

(71) Applicant: Peratech Holdco Limited, North Yorkshire (GB)

(72) Inventor: TIMOTHY PETER WILES, North Yorkshire (GB)

(21) Appl. No.: 17/880,747

(22) Filed: Aug. 4, 2022

Related U.S. Application Data
(63) Continuation of application No. PCT/GB2021/000008, filed on Feb. 3, 2021.

(30) Foreign Application Priority Data
Feb. 4, 2020 (GB) 2001545.9

(51) Int. Cl. G06F 3/041; G06K 9/62

(52) U.S. Cl. CPC G06F 3/04144; G06K 9/6279; G06F 3/0418

(57) ABSTRACT

A method of classifying a mechanical interaction on a sensing array is described. The sensing array comprises a plurality of sensing elements and the method comprises the steps of identifying positional (x,y) and extent (z) data in response to a mechanical interaction such as a finger press in the sensing array; converting the positional and extent data to image data to produce an image; and classifying the positional and extent data by providing the image to an artificial neural network.

### CROSS REFERENCE TO RELATED APPLICATIONS

This application is a continuation of International Patent Application number PCT/GB2021/000008, filed on 3 Feb. 2021, which claims priority from United Kingdom Patent Application number 20 01 545.9, filed on 4 Feb. 2020. The whole contents of International Patent Application number PCT/GB2021/000008 and United Kingdom Patent Application number 20 01 545.9 are incorporated herein by reference.

### BACKGROUND OF THE INVENTION

The present invention relates to a method of classifying a mechanical interaction and an apparatus for classifying a mechanical interaction.

Touch screens and electronic devices comprising touch screens are known which are configured to be responsive to applied pressures to effect desired outputs from the electronic device or touch screen itself.

Inputs are typically provided by a user by means of a finger press or a similar press by a stylus in the form of various gestures or swipes. Such gestures can be user-defined and more complex gestures require classification such that the processor of the electronic device can identify the required response. The present invention provides an improved technique for classifying such inputs irrespective of whether such inputs are static or dynamic.

US 2012/056846 A1 (ZALIVA VADIM [US]) published 8 Mar. 2012 discloses a touch-based user interface employing artificial neural networks. A touchpad includes an array of sensors used to create a tactile image of a type associated with the contact of a human hand. The tactile images include representations of numbers or shading in a plurality of cells.

### BRIEF SUMMARY OF THE INVENTION

According to a first aspect of the present invention, there is provided a method of classifying a mechanical interaction on a sensing array.

According to a second aspect of the present invention, there is provided an apparatus for classifying a mechanical interaction.

Embodiments of the invention will be described, by way of example only, with reference to the accompanying drawings. The detailed embodiments show the best mode known to the inventor and provide support for the invention as claimed. However, they are only exemplary and should not be used to interpret or limit the scope of the claims. Their purpose is to provide a teaching to those skilled in the art. Components and processes distinguished by ordinal phrases such as “first” and “second” do not necessarily define an order or ranking of any sort.

### BRIEF DESCRIPTION OF THE SEVERAL VIEWS OF THE DRAWINGS

FIG. 1 shows an example sensing array which can be incorporated into an electronic device comprising a touch screen;

FIG. 2 shows a schematic exploded view of an example sensing array;

FIG. 3 shows an electronic device comprising a touch screen and sensing array;

FIG. 4 shows a pixel array for use in a touch screen with the sensing array of FIG. 1;

FIG. 5 shows a user providing an input into an electronic device;

FIG. 6 shows an example image for classification following a mechanical interaction on the sensing array;

FIG. 7 shows an alternative example image for classification following a mechanical interaction from a user;

FIG. 8 shows an alternative electronic device in which a user may input a mechanical interaction which can then be classified;

FIG. 9 shows an image produced based on the positional and extent data provided by a user;

FIG. 10 shows a further example image produced for classification; and

FIG. 11 shows a method of classifying a mechanical interaction in a sensing array.

### DETAILED DESCRIPTION OF EMBODIMENTS OF THE INVENTION

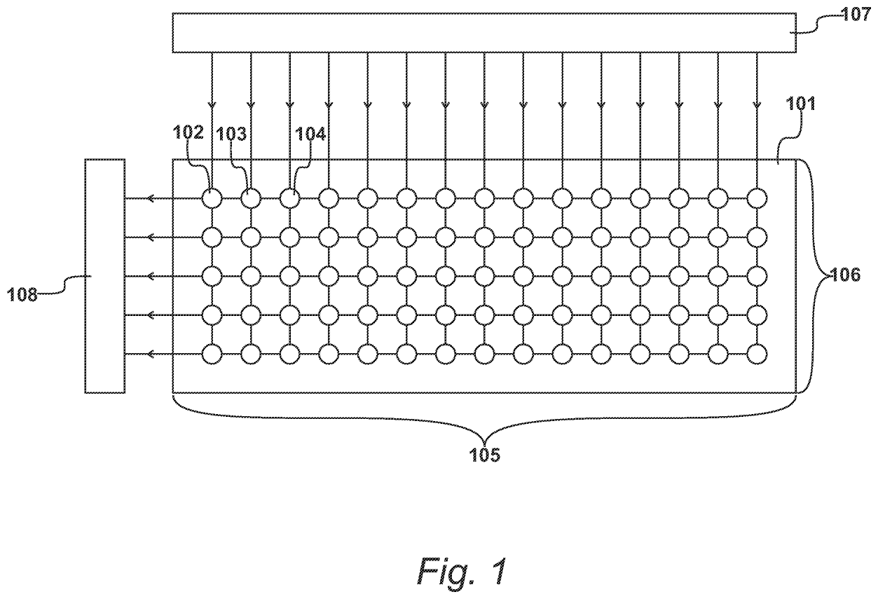

### FIG. 1

An example sensing array 101, which may be incorporated into an electronic device comprising a touch screen, is shown with respect to FIG. 1. Sensing array 101 is configured to provide a response to a mechanical interaction such as an applied force or applied pressure.

Sensing array 101 comprises a plurality of sensing elements such as 102, 103 and 104. In the embodiment, each sensing element comprises a pressure sensitive material which is responsive to an applied pressure. The pressure sensitive material may be of the type supplied by the applicant Peratech Holdco Limited under the trade mark QTC®, which includes material which exhibits a reduction in electrical resistance following the application of a force or pressure. In this way, the sensing array can be configured to provide both two-dimensional positional data (x,y) and an extent (z) property in response to an applied pressure. In this way, the x,y data can provide an indication of the location of a force input, and the z data can provide an indication of the magnitude of applied force by means of the pressure sensitive material.

In this illustrated example, sensing array 101 comprises fifteen columns 105 and five rows 106 in which the sensing elements are arranged and connected by conductors. In a further example embodiment, sensing array 101 comprises fifty columns and twenty-four rows. It is further appreciated that alternative arrangements fall within the scope of invention and that any other suitable number of rows and columns may be utilized. Furthermore, while the illustrated example describes a square array, it is appreciated that other alternative array forms may be utilized, for example, a hexagonal array or similar. However, in all embodiments, the sensing array comprises a plurality of sensing elements that are arranged and which are responsive to an application of force or pressure.

A column connector 107 receives driving voltages from a processor and a row connector 108 supplies scan voltages to the processor. Without the application of force or pressure, all of the sensing elements within sensing array 101 remain non-conductive. However, when sufficient pressure is applied to the sensing array in proximity to at least one of the sensing elements, that sensing element becomes conductive, thereby providing a response between an input driving line and an output scanned line. In this way, a positional property can then be identified and calculated by the processor in response to a mechanical interaction such as a finger press.

In some embodiments, a plurality of the sensing elements may become conductive or active in response to a mechanical interaction. However, in each case, positional data can be calculated based on the activated sensing elements.

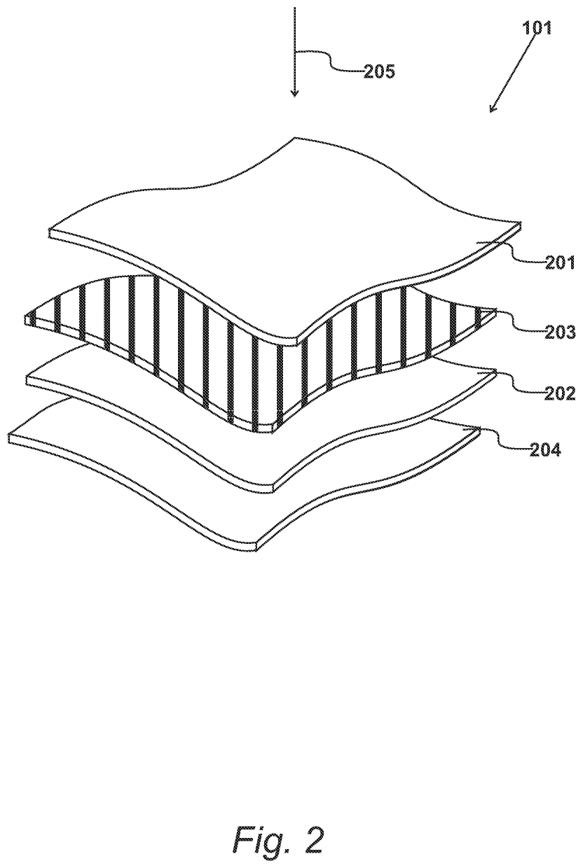

### FIG. 2

A schematic exploded example embodiment of the construction of sensing array 101 is shown in FIG. 2.

Sensing array 101 comprises a first conductive layer 201 and a second conductive layer 202. A pressure sensitive layer 203 is positioned between conductive layer 201 and conductive layer 202.

In the embodiment, the first conductive layer 201, second conductive layer 202 and pressure sensitive layer 203 are sequentially printed as inks onto a substrate 204 to form sensing array 101. First conductive layers 201 and 202 may comprise a carbon-based material and/or a silver-based material and pressure sensitive layer comprises a pressure sensitive material such as the type supplied by the applicant Peratech Holdco Limited under the trade mark QTC® as indicated previously. The pressure sensitive material therefore may comprise a quantum tunnelling composite material which is configured to exhibit a change in electrical resistance based on a change in applied force. The quantum tunnelling composite material may be supplied as a printable ink or film.

Each layer can be printed to form the pattern of the sensing array 101 as shown in the plan view of FIG. 1. In the embodiment, first conductive layer 201 comprises a plurality of conductive traces which form a plurality of rows across the array in a first direction. In contrast, second conductive layer 202 comprises a further plurality of conductive traces which form a plurality of columns across the array in a second direction. In the embodiment, the first and second directions are orientated at ninety degrees (90°) to each other.

Pressure sensitive layer 203 is printed to provide a plurality of sensing elements which are formed at the intersection of the rows and columns of the first and second conductive layers. Thus, the sensing elements and pressure sensitive layer in combination with the conductive layers can provide an extent property or intensity of a force applied, such as a force in the direction of arrow 205, in a conventional manner by interpretation of the electrical outputs.

While FIGS. 1 and 2 describe an example sensing array which is suitable for the present invention, it is acknowledged that alternative sensing arrays which are capable of providing both positional and extent property outputs may also be used in accordance with the present invention herein.

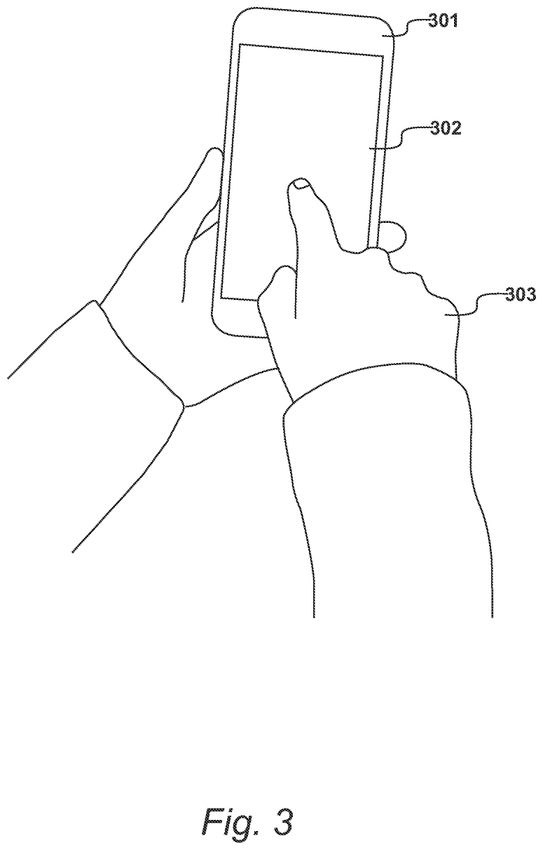

### FIG. 3

An example electronic device 301 comprises a touch screen 302 having a sensing array, such as sensing array 101 described previously. In the embodiment shown, electronic device 301 is a mobile telephone or smartphone, although it is appreciated that, in alternative embodiments, other electronic devices comprising touch screens may be utilized. Examples include, but are not limited to, display devices, personal computers, input devices or similar.

In an example scenario, user 303 provides a mechanical interaction or input gesture with their finger onto touch screen 302. In an embodiment, the input gesture provides an input which can be used as a security measure to allow access to the operating system and programs of the electronic device. In this way, user 303 may identify a gesture input known only to them to access or unlock the electronic device. The gesture may take the form of a trace or shape made by the user's finger or a series of sequential presses made by a user. In accordance with the invention, it is also possible that part of the gesture may be force dependent, such that the gesture is identified as having a press of a certain magnitude. Different magnitudes may also be identified, such as a higher magnitude followed by a lower magnitude. In this way, a user's security gesture may provide increased security even in the event that a third party views the input while the input takes place. In such cases, the user would no longer need to hide the touch screen from view when the input gesture is made as the third party would not be able to see the magnitude(s) of force applied during the mechanical input.

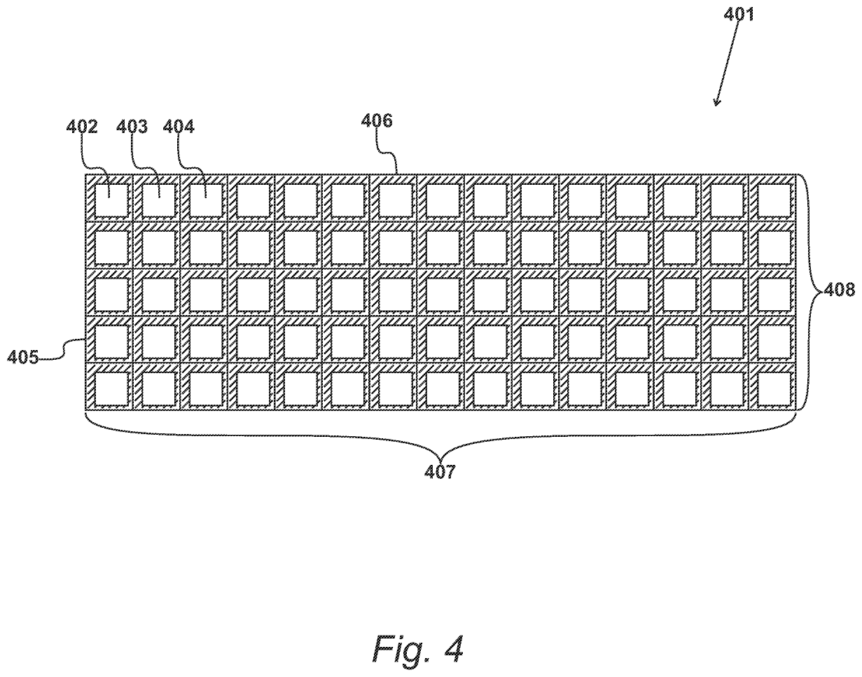

### FIG. 4

Touch screen 302 of electronic device 301 further comprises a pixel array, such as pixel array 401. Pixel array 401 comprises a plurality of pixels, such as pixels 402, 403 and 404 for example. Each of the pixels corresponds with one of the plurality of sensing elements of sensing array 101.

In the embodiment, the pixels of pixel array 401 are arranged as a first plurality of pixels arranged in rows, such as row 405, and a second plurality of pixels arranged in columns, such as column 406. In this illustrated example corresponding to previously described sensing array 101, pixel array 401 comprises fifteen columns 407 and five rows 408. In a further example embodiment, pixel array 401 comprises fifty columns and twenty-four rows in line with the similar embodiment of the sensing array. It is further appreciated that alternative arrangements fall within the scope of invention and that any other suitable number of rows and columns may be utilized. The arrangement, however, would be substantially similar to that of the sensing array 101.

Each pixel in pixel array 401 is configured to provide an output image, with each pixel comprising a three-layer color output. In an embodiment, the output image may therefore be provided as a three-layer color image, in which each of the layers corresponds to a different color. Conventionally, a first layer would correspond to a red output, a second layer would correspond to a green output and a third layer would correspond to a blue output to provide an RGB output.

In a further embodiment, the image may be output in grayscale format in which the range of black or white is determined from the force applied.

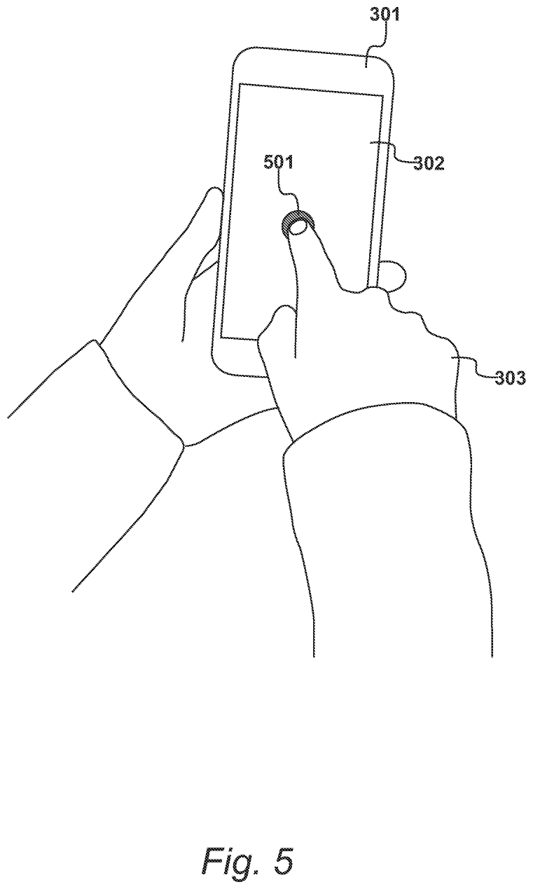

By combination of pixel array 401 and sensing array 101, the positional and extent data derived from sensing array 101 can be applied to pixel array 401 to provide an output which is determined from the positional and extent data. This will be described further in the examples of FIGS. 5 to 10.

### FIG. 5

User 303 is shown in FIG. 5 utilizing electronic device 301 by applying a force with their finger to touch screen 302. For illustrative purposes, the application of force is shown to provide a data input point 501. In some embodiments, this may create an image output onto touch screen 302 as shown, however, in other embodiments, as will now be described, this input data may be transmitted to the processor for processing to provide an alternative output in accordance with the input.

Creation of data input point 501 occurs in response to the mechanical interaction provided by user 303's finger. Thus, sensing array 101 processes this data from the finger press to identify positional and extent data thereby identifying the two-dimensional x,y location of the finger press, along with the magnitude or level of pressure or force applied at the identified location.

By mapping the sensing array positional and extent data to the pixel array 401, the positional data can be converted from an activated sensing element to corresponding pixel. Similarly, the extent data can be converted from the magnitude of force applied to a corresponding greyscale level.

In an example embodiment, the extent data is defined as a range of levels corresponding to a similar range of levels of greyscale. As an example, the magnitude of force applied is normalized to a scale between zero (0) and two hundred and fifty-five (255) to provide a standard 8-bit representation of the magnitude of force. In this way, 255 may be represent a high application of force with 0 representing a low application of force (such as a light touch) or no force at all. In this embodiment, the pixel array is correspondingly set such that the image data output is black at zero (0) and white at two hundred and fifty-five (255). Thus, a medium applied pressure may correspond to a mid-value of around 125 thereby outputting a grey image. In this way, pressure inputs of higher magnitude provide a lighter image than those of lower magnitude which are darker.

Once the positional and extent data from the sensing array has been converted to image data in this way, the image produced can be supplied to an appropriate artificial neural network (ANN).

An artificial neural network is understood to be able to provide image recognition on principle that, having received a data set of images meeting a given criteria, the ANN is then able to determine that a new image meets the criteria of that data set so as to provide confirmation of that image.

In an embodiment, the artificial neural network used is a convolutional neural network (CNN) which is pre-trained to interpret the image derived from data input point 501 as a predetermined gesture. For example, a user may apply a particular input with their finger at a given level of pressure. In a set-up scenario for electronic device 301, user 303 may be asked on screen to determine an acknowledgement gesture. User 303 may then be requested to repeatedly provide a mechanical interaction to provide the CNN (or alternative ANN) with a range of user-specified data that corresponds to the acknowledgement gesture. This data can then be stored in the form of a classification image such that the CNN, on receiving a mechanical interaction from a user at a later time, can ascertain that the mechanical interaction falls within an accepted range of acknowledgement gestures based on the classification image.

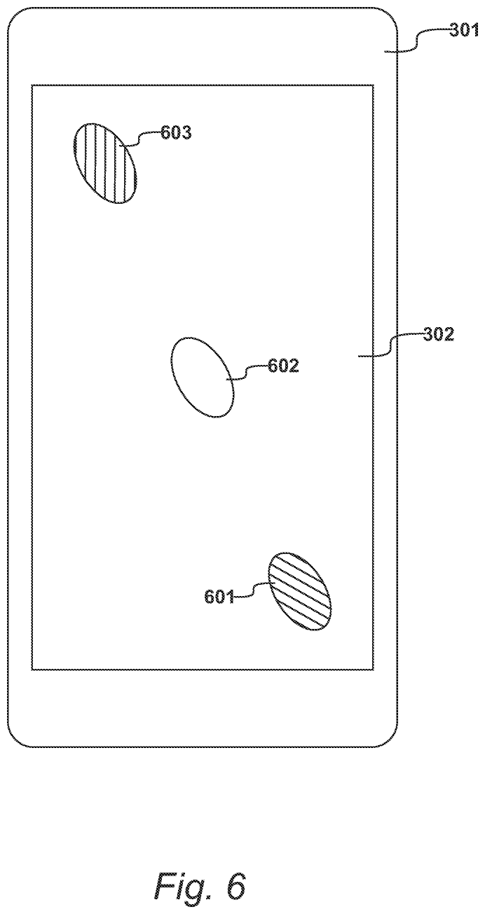

### FIG. 6

A further example of an image produced for classification of a mechanical interaction is shown in FIG. 6. Electronic device 301 is shown for illustrative purposes having received data input points 601, 602 and 603. In practice, user 303 has input a gesture over a period of time in which data input point 601 is received during a first frame, data input point 602 is received during a second frame and data input point 603 is received during a third frame. In this embodiment, the data input points are considered to have been input by a user applying a force by pressing in sequence over three separate locations on touch screen 302.

As explained previously, sensing array 101 is utilized to identify the positional and extent data in response to the user's mechanical interactions. Thus, the processor identifies x,y and z data from the sensing array. This data is then correlated with the pixel array to produce image data covering both the positional and extent properties of the force applied.

In this embodiment, positional and extent data is taken dynamically, and each data input point has been taken at a different frame. Thus, for the first frame, data input point 601 is established identifying the position of the pressure input as shown. Extent data can also be applied to provide a level of color or brightness.

In the embodiment, pixel array 401 comprises an RGB color image, rather than greyscale, and, consequently, each frame corresponds to a different layer of the RGB image and correspondingly a different color. Thus, in this example, data input point 601 provides a red output image of an intensity corresponding to the magnitude of force (of a brightness or level of redness between 0 and 255). As data input point 601 is red in color, this indicates that the data input point was made during the first frame.

During the second frame, data input point 602 is identified, of which the positional and extent data in response to this data input is converted into an image that is green in color, thereby identifying that this force input has taken place in the second frame. Similarly, data input point 602 may also include extent data which provides a level of green (of varying brightness) which indicates the level of force applied.

During the third frame, data input point 603 is produced in a similar manner, with a corresponding blue output. Thus, in this way the image layer showing each data input point provides an indication of location data, magnitude of force and the dynamic element illustrating dynamic movement of the gesture by nature of the color changes.

This enables the artificial neural network to be presented with image data representing more complex gesture inputs, measured over a period of time (such as frame by frame) for classification.

As indicated previously, during a set-up process, a user may be requested to provide repeated gestures of similar scope so as to identify a security gesture to access the electronic device. This repeated mechanical interaction can then be used to provide a data set to identify a classification image which the artificial neural network can use to classify any future inputs as being valid or invalid. By providing the color image an additional dynamic parameter identifying movement of the gesture over a period of time can be identified.

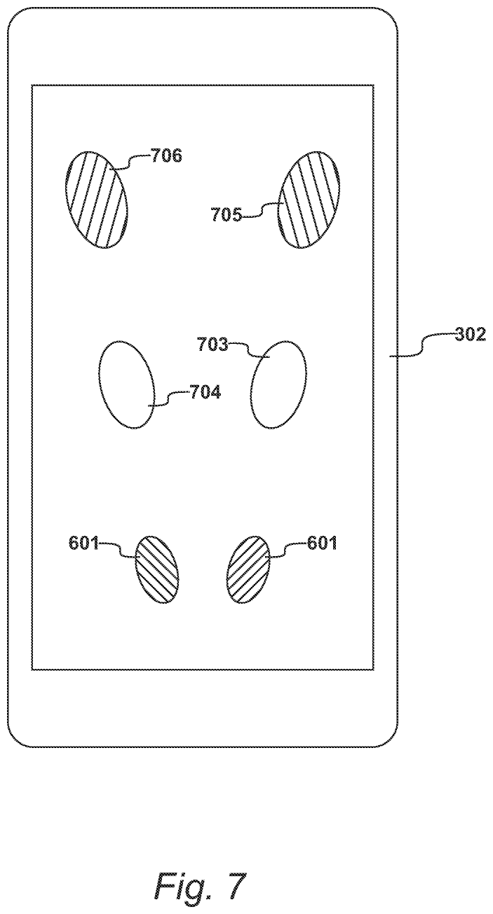

### FIG. 7 An alternative example of an image produced for classification of a mechanical interaction is shown in FIG. 7.

In this image, data input points 701 and 702 are shown of a similar color identifying that they were input at the same frame. Thus, in this image, it is understood that a user in the first frame of the image shown in FIG. 7 provided two pressure inputs with separate fingers indicated by data input point 701 and 702 respectively. At the second frame, the user has moved each finger to correspond to data input points 703 and 704 which are again identified as a mechanical interaction taking place in the same frame due to both points 703 and 704 producing the same color image. The same applies in the third frame in which a user has again moved both fingers to coincide with data input points 705 and 706.

Thus, it is noted that the different color channels provided from the pixel array can be used to identify the movement over time of the gesture by means of the three-layer color image, even in a case where multiple inputs are received from the sensing array, such as, in this case, where two separate finger inputs are identified at a given moment. It is also appreciated that, in the case where a user input is not moving, as per FIG. 5 the output image will be produced as a greyscale image rather than in color.

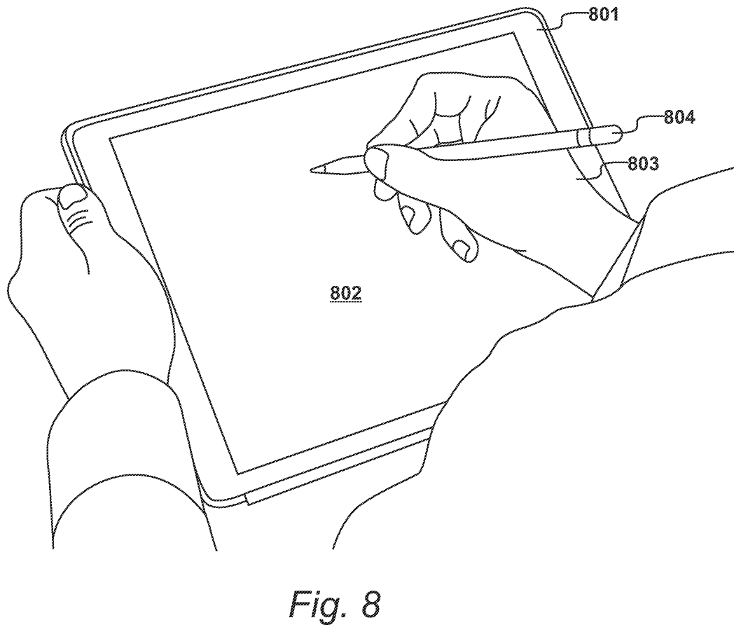

### FIG. 8

A further electronic device 801 in an example embodiment in accordance with the invention is shown in FIG. 8. Electronic device 801 comprises a hand-held tablet computer of the type known in the art. Electronic device 801 comprises a touch screen 802 and is configured to received mechanical interactions from user 803 by means of an input device 804, such as a stylus.

Electronic device 801 comprises a sensing array and pixel array which may be substantially similar to those previously described herein. Functionally, electronic device 801 may be substantially similar to electronic device 301 and may also receive alternative inputs to those delivered from a stylus.

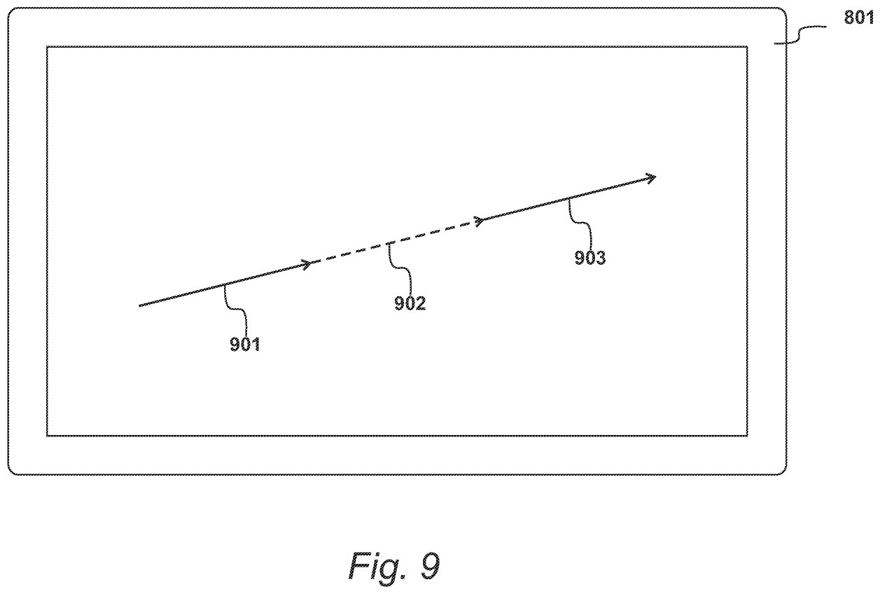

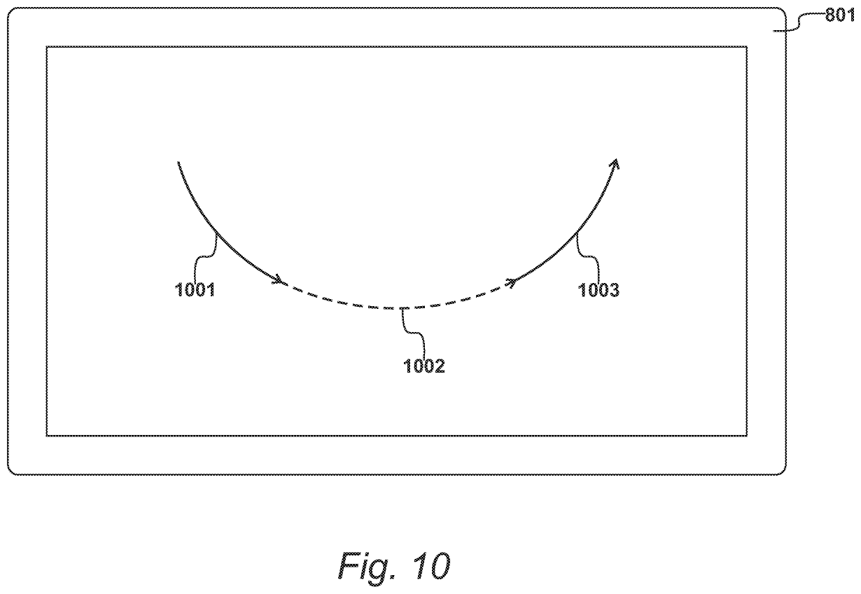

In an example scenario, user 803 provides a mechanical interaction or input gesture with the stylus onto touch screen 802 which provides positional and extent data to the sensing array. This is then converted to image data to produce an image such as those shown in FIGS. 9 and 10.

### FIG. 9

Electronic device 801 is shown having produced an image based on the positional and extent data provided by user 803 in response to a mechanical interaction from input device 804.

The image produced shows a continuous line extending across the sensing array and corresponding touch screen indicating the path of the pressure input. In this illustrated embodiment, the image data has again been recorded over a series of frames with each frame corresponding to a different color output so as to provide a three-layer image. Consequently, the image produced comprises first data input 901 corresponding to an input received in a first frame, second data input 902 corresponding to an input received in a second frame, and third data input 903 corresponding to an input received in a third frame.

As mapping of the positional data is correlated with each color layer, the direction of travel can also be identified since the color order is known in relation to the frames. Thus, if the output image of data input 901 is red, data input 902 is green and data input 903 is blue, it can be determined that the direction of travel is in line with the arrows depicted in FIG. 9. In the event that, for example, the output image of data input 901 is blue, data input 902 is green and data input 903 is red, it can correspondingly be determined that the same positional line comprised a gesture in the opposite direction due to the color mapping. In this way, a gesture input to produce a similar image, but that has been created in a different manner can be identified as being invalid.

### FIG. 10

A further example image produced in response to a mechanical interaction on electronic device 801 is shown in FIG. 10.

The image shown identifies a curved path across the sensing array and touch screen of electronic device 801. In this example embodiment, the image data has been recorded over a series of frames with each frame corresponding to a different color output so as to provide a three-layer image. Consequently, the image produced comprises first data input 1001 corresponding to an input received in a first frame, second data input 1002 corresponding to an input received in a second frame, and third data input 1003 corresponding to an input received in a third frame. As with the example shown in FIG. 9, the direction of travel can be identified by comparing the color outputs of each layer with each data input to determine the direction of travel.

In this particular case, in addition to the changes in positional data taken from the sensing array, extent data has been identified in which the force applied varies with each frame.

In the example, data input 1001, in which the output image shows a red curve indicating an input during a first frame is followed by data input 1002, which shows a green curve indicating an input during a second frame. In the image, the red and green curves of data inputs 1001 and 1002 respectively are considered to provide a similar brightness. However, in respect of data input 1003, the image is presented of a higher brightness which indicates that the force applied is substantially higher than that received in response to the mechanical interaction for data inputs 1001 and 1002.

In this way, a further variation in image data represents a further difference in the type of gesture produced, allowing for the system to identify further differentials from one gesture to another.

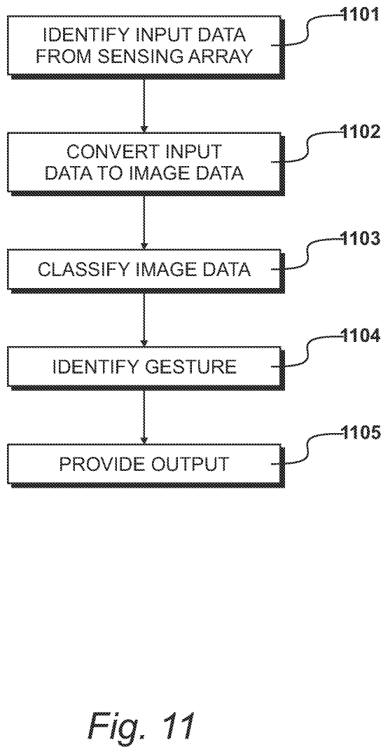

### FIG. 11

A method of classifying a mechanical interaction on a sensing array is summarized in schematic form in FIG. 11. At step 1101 a sensing array, such as sensing array 101 receives a mechanical interaction and positional and extent data is identified in response to the mechanical interaction. The mechanical interaction, as described herein, may comprise an applied pressure or force generated from, for example, a finger press or from an input device such as a stylus. In an embodiment, the positional and extent data comprises two-dimensional x,y location data and a magnitude of force applied.

At step 1102, the positional and extent input data is converted to image data to produce an image, such as the images described previously. The image may comprise a three-layer image in which each layer corresponds to a different color output, for example, an RGB output which is recorded on a frame-by-frame basis such that each color corresponds to a different frame. The extent data identified at step 1101 can also be represented in the image by defining the extent data as a range of levels which correspond to a numerically similar range of levels of each said color output. In this way, the value of the extent data can be presented in the image by the brightness of the color output. For example, a higher force applied may result in a brighter color output.

At step 1103, the positional and extent data is classified by providing the produced image to an artificial neural network. The artificial neural network reviews the image and compares this with its previously acquired data set so as to identify a predetermined gesture. It is appreciated that images may have been previously provided to the artificial neural network in a pre-training step so that a gesture can be identified. This process may also include a user providing a repeated mechanical interaction to the artificial neural network to establish a classification image which is identified as being representative of the predetermined gesture. In this way, the artificial neural network can then classify the image data as being a form of the predetermined gesture or not.

The artificial neural network is further configured to remove background noise from the inputs in order to assist in the classification of the image data, and this may be achieved by comparing new image data with a previously stored reference data indicating background noise already present in the electronic device and touch screen.

Thus, at step 1104, the artificial neural network identifies the gesture and may provide an output to a user at step 1105 thereby confirming the classification step in response to the mechanical interaction. The output provided may take the form of an output image or be used as an instruction to activate other algorithms or programs in the electronic device. For example, in the previously described security example, the gesture presented in the form of a mechanical interaction may unlock the screen of the electronic device and allow a user to view a start-up screen. In a similar way, a mechanical interaction may result in an output in which a program or application is activated on the electronic device in response to a gesture applied by a user.

The invention claimed is:

1. A method of classifying a mechanical interaction on a sensing array, said sensing array comprising a plurality of sensing elements, said method comprising the steps of:
identifying positional and extent data in response to said mechanical interaction on said sensing array;
converting said positional and extent data to image data to produce an image recorded over a series of frames, said image comprising a three-layer image, and each layer corresponding to a different color output measured over a period of time; and
classifying said positional and extent data by providing said image to an artificial neural network.

2. The method of claim 1, wherein said step of identifying positional and extent data identifies two-dimensional location data and a magnitude of force applied.

3. The method of claim 1, wherein said extent data is defined as a range of levels corresponding to a numerically similar range of levels of each said color output.

4. The method of claim 1, wherein a value of said extent data is presented in said image by a brightness of said color output.

5. The method of claim 1, wherein said artificial neural network is a convolutional neural network.

6. The method of claim 5, further comprising the step of:
pre-training said convolutional neural network to interpret said image as a predetermined gesture.

7. The method of claim 1, further comprising the step of:
providing a repeated mechanical interaction to said artificial neural network to establish a classification image.

8. The method of claim 1, further comprising the step of:
removing background noise by means of said artificial neural network.

9. The method of claim 1, further comprising the step of:
confirming said classification step by providing an output in response to said mechanical interaction.

10. A touch screen comprising said sensing array and a processor configured to perform the method of claim 1.

11. Apparatus for classifying a mechanical interaction, comprising:
a sensing array comprising a plurality of sensing elements, said plurality of sensing elements being configured to become active in response to said mechanical interaction;
a processor configured to perform the steps of:
identifying positional and extent data in response to said mechanical interaction;
converting said positional and extent data to image data to produce an image recorded over a series of frames, said image comprising a three-layer image, and each layer corresponding to a different color output measured over a period of time; and
classifying said positional and extent data by providing said image to an artificial neural network.

12. The apparatus of claim 11, wherein said sensing array comprises a first plurality of sensing elements arranged in rows and a second plurality of sensing elements arranged in columns; and
said image comprises a corresponding first plurality of pixels arranged in rows and a corresponding second plurality of pixels arranged in columns.

13. The apparatus of claim 12, wherein a value of said extent data is presented in said image by a brightness of said color output.

14. The apparatus of claim 11, wherein said artificial neural network is a convolutional neural network.
